(19) United States
(12) Patent Application Publication
(10) Pub. No.: US 2016/0128042 A1
(43) Pub. Date: May 5, 2016

(54) METHOD AND APPARATUS FOR SIMULTANEOUSLY TRANSMITTING DATA

(71) Applicant: Electronics and Telecommunications Research Institute, Daejeon (KR)

(72) Inventors: Eun-Young CHOI, Daejeon (KR); Young Seog SONG, Daejeon (KR); Seung Eun HONG, Daejeon (KR); Il Gyu KIM, Okcheon-gun (KR); Seung Chan BANG, Daejeon (KR)

(21) Appl. No.: 14/926,251

(22) Filed: Oct. 29, 2015

(30) Foreign Application Priority Data
Oct. 29, 2014 (KR) 10-2014-0148666

(51) Int. Cl. H04W 72/04

(52) U.S. Cl. CPC H04W 72/044; H04W 72/1263

(57) ABSTRACT

A method and apparatus for simultaneously transmitting data to a plurality of terminals are provided. The method includes: selecting a plurality of simultaneous transmitting terminals based on a signal-to-noise ratio (SNR) of the plurality of terminals; allocating a power rate of the plurality of simultaneous transmitting terminals to each of the plurality of simultaneous transmitting terminals; modulating each of the data according to a modulation method that is determined based on the power rate; and transmitting the modulated data according to the power rate.

### CROSS-REFERENCE TO RELATED APPLICATION

This application claims priority to and the benefit of Korean Patent Application No. 10-2014-0148666 filed in the Korean Intellectual Property Office on Oct. 29, 2014, the entire contents of which are incorporated herein by reference.

### BACKGROUND OF THE INVENTION

(a) Field of the Invention

The present invention relates to a method and apparatus for simultaneously transmitting data to a plurality of terminals.

(b) Description of the Related Art

A multiple access method is a method of dividing a frequency, time, or code resource and allocating a resource between a base station and a terminal. The multiple access method includes a frequency division multiple access (FDMA) method, a time division multiple access (TDMA) method, and a code division multiple access (CDMA) method. A method of allocating different frequency or time resources to each terminal when transmitting data to a terminal like FDMA and TDMA is referred to as an orthogonal multiple access (OMA) method, and may minimize interference between terminals. A method of allocating the same frequency or time resource to an entire terminal like CDMA is referred to as a non-orthogonal multiple access (NOMA) method, and may simultaneously transfer data to several terminals.

In a case of selecting a multiple access method in consideration of opportunity fairness, when transmitting data to each terminal, FDMA and TDMA methods should allocate other resources. Therefore, in such a case, communication quality may be changed according to a state of a resource that is allocated to a specific terminal.

### SUMMARY OF THE INVENTION

The present invention has been made in an effort to provide a method and apparatus having advantages of being capable of using the same time and frequency resource and transmitting data to at least two terminals.

An exemplary embodiment of the present invention provides a method of simultaneously transmitting data to a plurality of terminals. The method includes: selecting a plurality of simultaneous transmitting terminals based on a signal-to-noise ratio (SNR) of the plurality of terminals; allocating a power rate of the plurality of simultaneous transmitting terminals to each of the plurality of simultaneous transmitting terminals; modulating each of the data according to a modulation method that is determined based on the power rate; and transmitting the modulated data according to the power rate.

The selecting of a plurality of simultaneous transmitting terminals may include: determining whether to simultaneously transmit to the simultaneous transmitting terminals; and determining the number of simultaneous transmitting terminals.

The determining of whether to simultaneously transmit may include: selecting a first terminal of the plurality of terminals according to a priority transmitting order as the simultaneous transmitting terminal; and determining whether to simultaneously transmit in consideration of a size or a kind of first data to transmit to the first terminal.

The determining of the number of the simultaneous transmitting terminals may include: determining the number of the simultaneous transmitting terminals in consideration of a channel environment of the first terminal; and selecting, when there are 2 simultaneous transmitting terminals, a second terminal of the plurality of terminals as the simultaneous transmitting terminal in consideration of an SNR of the first terminal.

The selecting of a second terminal may include: dividing an SNR of the plurality of terminals into n segments according to intensity; selecting a second segment at remaining n-1 segments instead of a first segment of the n segments, when an SNR of the first terminal belongs to a first segment of the n segments; and selecting a second terminal having an SNR corresponding to the second segment.

The allocating of a power rate may include allocating, when an SNR of the first terminal is larger than that of the second terminal, a power rate larger than that of the first terminal to the second terminal.

The modulating of each of the data may include modulating, when an SNR of the first segment is largest at the n segments, the first data with a 16 quadrature amplitude modulation (QAM) method.

The modulating of each of the data may include modulating, when an SNR of the first segment is smallest at the n segments, the first data with a quadrature phase shift keying (QPSK) method.

The modulating of each of the data may include changing and modulating a modulation order of the first data and second data to transmit to the second terminal.

The determining of the number of simultaneous transmitting terminals may include: determining the number of simultaneous transmitting terminals in consideration of a channel environment of the first terminal; and selecting, when there are 3 simultaneous transmitting terminals, a second terminal of the plurality of terminals as the simultaneous transmitting terminal in consideration of an SNR of the first terminal, and selecting a third terminal of the plurality of terminals as the simultaneous transmitting terminal in consideration of an SNR of the second terminal.

The selecting of a third terminal may include: classifying an SNR of the plurality of terminals into m segments according to intensity; and selecting at least one of the simultaneous transmitting terminals at a segment in which the SNR is largest among the m segments.

The allocating of a power rate may include, when an SNR of the first terminal is smallest, an SNR of the second terminal is largest, and an SNR of the third terminal is larger than that of the first terminal and is smaller than that of the second terminal, allocating a largest power rate to the first terminal, allocating a smallest power rate to the second terminal, and allocating a power rate smaller than a power rate that is allocated to the first terminal and larger than a power rate that is allocated to the second terminal to the third terminal.

The modulating of each of the data may include modulating the first data, second data to transmit to the second terminal, and third data to transmit to the third terminal with a quadrature phase shift keying (QPSK) method.

The modulating of each of the data may include changing and modulating each modulation order of the first data, second data to transmit to the second terminal, and third data to transmit to the third terminal.

Another embodiment of the present invention provides an apparatus that simultaneously transmits data to a plurality of terminals. The apparatus includes: a terminal selection processor that selects a plurality of simultaneous transmitting terminals based on a signal-to-noise ratio (SNR) of the plurality of terminals, and that allocates a power rate to each of the plurality of simultaneous transmitting terminals; and a mapper that modulates each of the data according to a modulation method that is determined based on the power rate and that outputs the modulated data according to the power rate.

The terminal selection processor may select a first terminal of the plurality of terminals as the simultaneous transmitting terminal according to a priority transmitting order, determine whether to simultaneously transmit, and determine the number of simultaneous transmitting terminals in consideration of a size or a kind of first data to transmit to the first terminal.

The terminal selection processor may determine the number of simultaneous transmitting terminals in consideration of a channel environment of the first terminal and select a second terminal of the plurality of terminals as the simultaneous transmitting terminal in consideration of an SNR of the first terminal, when there are 2 simultaneous transmitting terminals.

The terminal selection processor may determine the number of simultaneous transmitting terminals in consideration of a channel environment of the first terminal, select a second terminal of the plurality of terminals as the simultaneous transmitting terminal in consideration of an SNR of the first terminal, and select a third terminal of the plurality of terminals as the simultaneous transmitting terminal in consideration of an SNR of the second terminal, when there are 3 simultaneous transmitting terminals.

The terminal selection processor may determine a modulation order and a code rate of the data and transmit the modulation order and the code rate to the mapper, and the mapper may modulate each of the data based on the modulation order and the code rate.

The terminal selection processor may determine a relative magnitude of the power rate and allocate the relative magnitude to the plurality of simultaneous transmitting terminals, and the mapper may modulate each of the data according to a predetermined modulation method based on the relative magnitude.

### BRIEF DESCRIPTION OF THE DRAWINGS

FIG. 1 is a diagram illustrating a mobile communication system including a base station and a terminal according to an exemplary embodiment of the present invention.

FIG. 2 is a block diagram illustrating a transmitter according to an exemplary embodiment of the present invention.

FIG. 3 is a diagram illustrating a constellation of a signal that is output with a power rate according to an exemplary embodiment of the present invention.

FIG. 4 is a diagram illustrating a constellation of a signal that is output with a power rate according to another exemplary embodiment of the present invention.

FIG. 5 is a diagram illustrating a receiving terminal according to an exemplary embodiment of the present invention.

FIG. 6 is a flowchart illustrating a method in which a base station selects a simultaneous transmitting terminal according to an exemplary embodiment of the present invention.

FIG. 7 is a diagram illustrating an SNR segment of a terminal according to an exemplary embodiment of the present invention.

FIG. 8 is a diagram illustrating an SNR segment of a terminal according to another exemplary embodiment of the present invention.

FIG. 9 is a flowchart illustrating a method of generating a signal according to an exemplary embodiment of the present invention.

FIG. 10 is a block diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In an entire specification, a mobile station (MS) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node (RN) that performs a BS function, an advanced relay station (ARS) that performs a BS function, a high reliability relay station (HR-RS) that performs a BS function, and a small-sized BS [a femto BS, a home node B (HNB), a home eNodeB (HeNB), a pico BS, a metro BS, and a micro BS], and may include an entire function or a partial function of the ABS, the nodeB, the eNodeB, the AP, the RAS, the BTS, the MMR-BS, the RS, the RN, the ARS, the HR-RS, and the small-sized BS.

The present invention provides a mode change method of removing a partial resource, i.e., a predetermined specific mode or band, of a system that is set to and operates in a specific mode or band in a cloud base station system that processes a system resource with a centralized method, and reconfiguring a system with the same mode or band as the removed system resource or with a new mode or band that is not the same as the removed system resource.

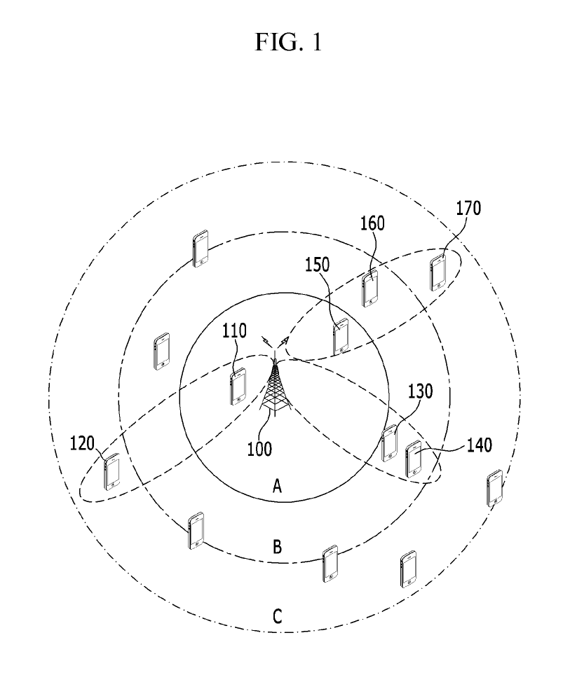

FIG. 1 is a diagram illustrating a mobile communication system including a base station and a terminal according to an exemplary embodiment of the present invention.

In a multiple access method, when simultaneously transmitting data to several terminals using the same resource, transmission power may be differently allocated to each terminal. In this case, when total transmission power of a base station 100 to a terminal is 1, transmission power of a magnitude smaller than 1 may be allocated to each terminal. In this case, each terminal receives all data that are transmitted from the base station 100 to all terminals at a transmitting time point, and demodulates the received data according to power that is allocated to each terminal.

When power is allocated with the above method, an estimated capacity of each terminal in consideration of fairness may be expressed with Equation 1.

C_{UE1}=log₂(1+SNR_{UE1}), C_{UE2}=log₂(1+SNR_{UE2}), . . . , C_{UEn}=log₂(1+SNR_{UEn}) (Equation 1)

In Equation 1, an SNR_{UE} representing a signal-to-noise ratio (SNR) of each terminal is reduced smaller than a transmission power rate when the base station 100 allocates all transmission power to one terminal (i.e., a transmission power rate=1). At least one terminal may be selected for one resource based on a transmitting time point of data. In this case, even when data that is transmitted to each terminal operates as interference of another terminal, in order to demodulate data, the number of terminals (hereinafter referred to as ‘simultaneous transmission terminals’) that can simultaneously transmit maximum data to the base station 100 may be 3.

An SNR of the terminal according to a magnitude of allocated power may be calculated by Equation 2.

$${SNR}_{{UE}_{HPR}} = \frac{{SNR}_{HP} * UE\_HPR}{{SNR}_{HP} * ( 1 - UE\_HPR ) + 1} \\ {SNR}_{UE\_MPR} = \frac{{SNR}_{MP} * UE\_MPR}{{SNR}_{MP} * ( 1 - UE\_HPR - UE\_MPR ) + 1} \\ {SNR}_{UE\_LPR} = \frac{{SNR}_{LP} * UE\_LPR}{1} \qquad ( Equation 2 )$$

In Equation 2, a UE_HPR is a high power rate (HPR) that is allocated to user equipment (UE), a UE_MPR is a medium power rate (MPR) that is allocated to the UE, and a UE_LPR is a low power rate (LPR) that is allocated to the UE. Further, SNR_{HP}, SNR_{MP}, and SNR_{LP} are SNRs representing an input channel state of each UE and are SNRs when the base station 100 allocates all transmission power to one UE.

For example, when the base station 100 transmits data to two UEs of a UE1 110 and a UE 2 120, an SNR of the UE1 110 may be 20 dB and an SNR of the UE2 120 may be 10 dB. That is, an SNR of the UE2 120 that is located at a location far from the base station 100 is lower. In this case, when TDMA or FDMA is applied, the base station 100 uses the same frequency resource or the same time resource, and thus a resource use rate of each UE becomes half. A capacity of the UE1 110 may be 3.33 bits/s/Hz, and a capacity of the UE2 120 may be 1.73 bits/s/Hz.

However, according to an exemplary embodiment of the present invention, when power is differently allocated to each UE and is simultaneously transmitted (a power ratio of the UE1 110 and the UE2 120 is 0.2:0.8), capacity of the UE1 110 is 4.39 bit/s/Hz and capacity of the UE2 120 is 1.87 bit/s/Hz. That is, according to an exemplary embodiment of the present invention, when power that is allocated to each UE is differently set, the UE1 110 shows a performance improvement of about 32% and the UE2 120 shows a performance improvement of about 8%.

In a multi-terminal transmission method according to an exemplary embodiment of the present invention, power may be differently allocated according to a channel state of each UE. For example, a relatively large amount of power may be allocated to a UE not having a good channel state, and a relatively small amount of power may be allocated to a UE having a good channel state. This is because, even if a small amount of power is allocated to a UE having a good channel state, data can be transmitted and received.

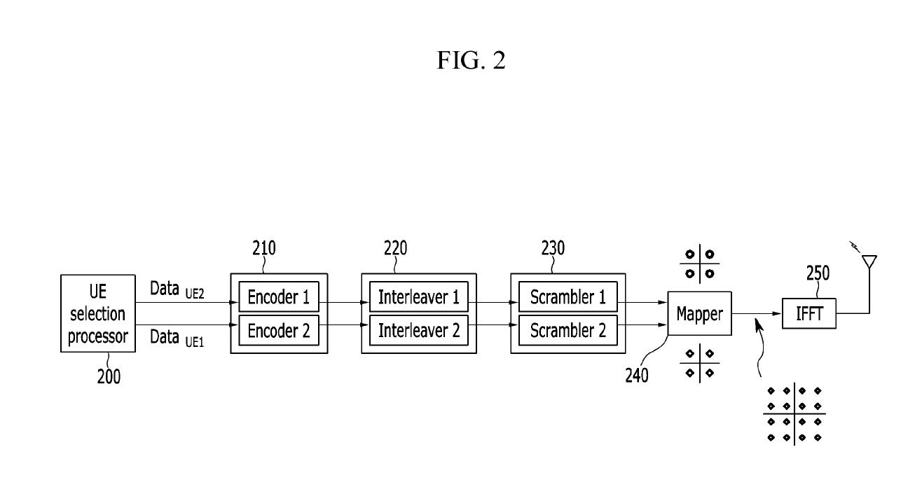

FIG. 2 is a block diagram illustrating a transmitter according to an exemplary embodiment of the present invention.

Referring to FIG. 2, a transmitter according to an exemplary embodiment of the present invention includes a UE selection processor 200 (also called a terminal selection processor), an encoder 210, an interleaver 220, a scrambler 230, a mapper 240, and an inverse fast Fourier transform (IFFT) unit 250.

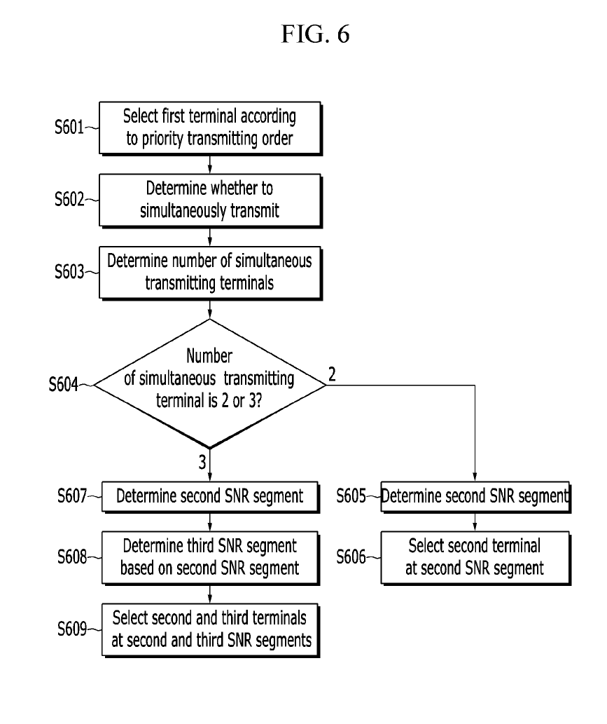

The UE selection processor 200 selects a simultaneous transmitting UE based on a channel state of each UE that is connected to the base station 100. In this case, the base station 100 may determine a channel state of each UE based on SNR information that is received from a plurality of UEs. Further, the UE selection processor 200 may determine a power rate of each simultaneous transmitting UE. For example, the UE selection processor 200 may determine a relative magnitude of a power rate of each simultaneous transmitting UE. Alternatively, the UE selection processor 200 may specifically determine an absolute magnitude of a power rate of each simultaneous transmitting UE. Hereinafter, a function of the UE selection processor 200 will be described in detail with reference to FIGS. 6 to 9.

The encoder 210 encodes data that it sends to each UE on each data basis.

The interleaver 220 interleaves encoded data on each data basis.

The scrambler 230 scrambles interleaved data on each data basis. After data to be transmitted to each UE is scrambled, the data is modulated in the mapper 240 according to a predetermined modulation method.

The mapper 240 converts data that it sends to each UE to a modulation order of each UE. The mapper 240 multiplies a power rate by data according to a determined power magnitude based on a channel state and information about a simultaneous transmitting UE. In this case, the sum of ratios of the power rate is 1. Thereafter, the mapper 240 synthesizes modulated data into one constellation. Referring to FIG. 2, a constellation of the UE2 120 is set to a basic constellation, and a constellation of the UE1 110 is set to a subordinate constellation.

In this case, output of the mapper 240 may be represented by a sum of values that are products of power to a modulation order of each UE. That is, because the mapper 240 multiplies a power rate by data to transmit to each terminal, an effect in which a modulation order is raised may be represented. Referring to FIG. 2, data to be transmitted to the UE1 110 and the UE2 120 is modulated with a Quadrature Phase Shift Keying (QPSK) method, but different modulation methods may be applied to each data. A modulation method that is determined according to a power allocation rate and a modulation order (representing an order of constellations) is applied to data to be transmitted to each terminal.

The IFFT unit 250 performs inverse Fourier transform of data that is modulated with one constellation. Thereafter, an inverse Fourier transformed signal is output through an antenna. In this case, power of a finally output signal is set to 1, and a magnitude of power that is allocated to each terminal is expressed with a ratio. In an exemplary embodiment of the present invention, data of a terminal (hereinafter referred to as an ‘HPR terminal’) to which a high power rate is allocated becomes a basic constellation, and data of a terminal (hereinafter referred to as an ‘LPR terminal’) to which a smaller power rate is allocated becomes a subordinate constellation. In the present invention, a high power rate may be allocated to a terminal having a relatively not good channel state.

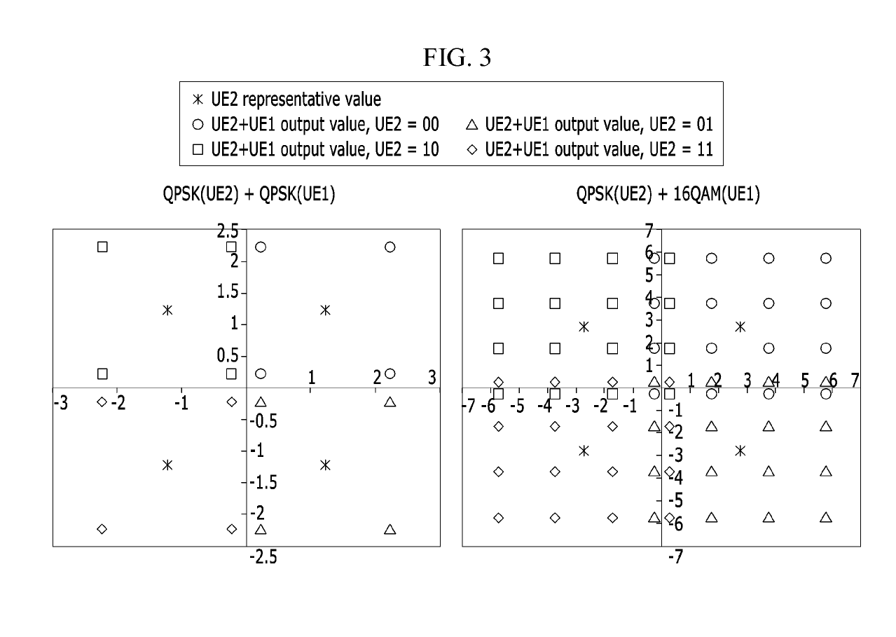

In a left drawing of FIG. 3, both data of the UE1 110 and data of the UE2 120 were modulated with a QPSK method, a power rate of 0.6 was allocated to the UE2 120, and a power rate of 0.4 was allocated to the UE1 110. In this case, when data approaches a horizontal axis and a vertical axis, the data may be easily affected by even a little noise, and performance thereof may be deteriorated.

In a right drawing of FIG. 3, data of the UE1 110 was modulated with a 16 quadrature amplitude modulation (QAM) method, and data of the UE2 120 was modulated with a QPSK method. A power rate that is allocated to the UE2 120 is 0.6, and a power rate that is allocated to the UE1 110 is 0.4. In this case, because interference between data may excessively occur, performance may be deteriorated.

Therefore, because data of the HPR terminal and data of the LPR terminal may have interference, it is necessary to select a power rate that is allocated to the terminal in a range in which interference does not occur.

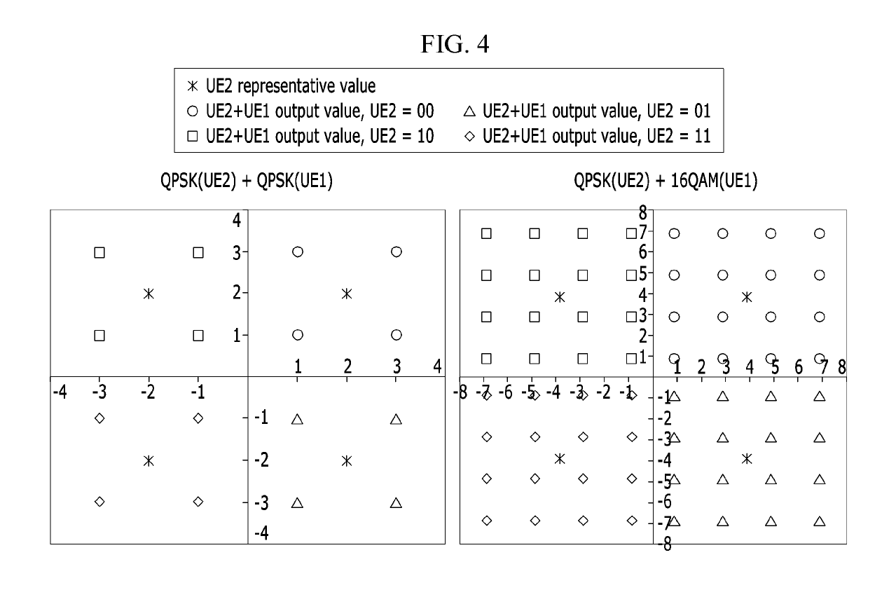

FIG. 4 is a diagram illustrating a constellation of a signal that is output with a power rate according to another exemplary embodiment of the present invention.

In a left drawing of FIG. 4, both data of the UE1 110 and data of the UE2 120 were modulated with a QPSK method, a power rate of 0.8 was allocated to the UE2 120, and a power rate of 0.2 was allocated to the UE1 110. In this case, data may be displayed similarly to a constellation point of 16QAM.

In a right drawing of FIG. 4, data of the UE1 110 was modulated with a 16QAM method, and data of the UE2 120 was modulated with a QPSK method. A power rate of 0.75 was allocated to the UE2 120, and a power rate of 0.25 was allocated to the UE1 110. In this case, data may be displayed similarly to a constellation point of 64QAM.

Therefore, unlike a case of FIG. 3, as a difference of a power rate that is allocated to two terminals largely increases, interference in the same modulation method can be reduced. Further, a large difference of a power rate is advantageous in a modulation method of a high code rate.

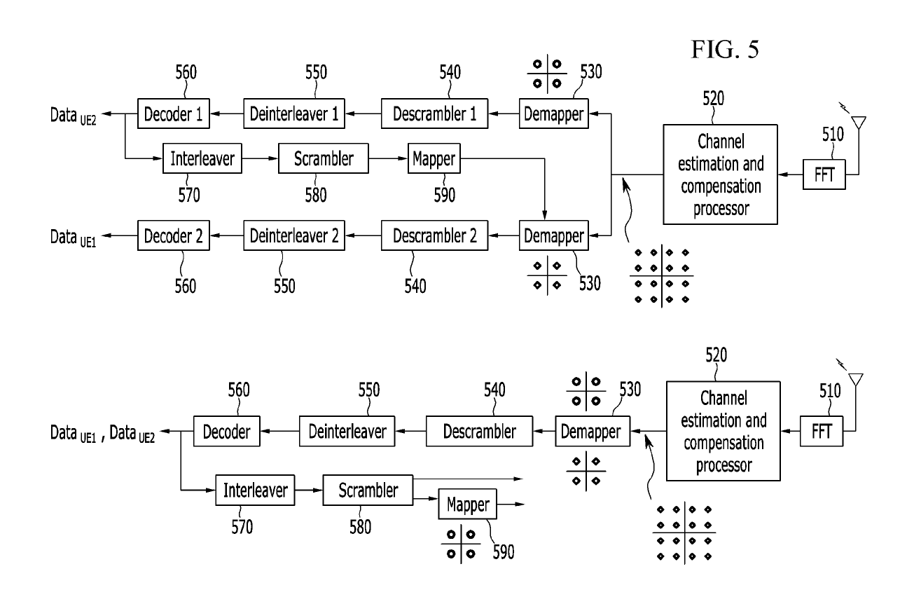

FIG. 5 is a diagram illustrating a receiving terminal according to an exemplary embodiment of the present invention.

Referring to FIG. 5, a receiving terminal according to an exemplary embodiment of the present invention includes an FFT unit 510, a channel estimation and compensation processor 520, a demapper 530, a descrambler 540, a deinterleaver 550, and a decoder 560. A receiver according to an exemplary embodiment of the present invention may further include an interleaver 570, a scrambler 580, and a mapper 590.

The FFT unit 510 converts a received signal to a signal of a frequency domain.

The channel estimation and compensation processor 520 estimates a channel using a reference signal and compensates data using a channel estimation result.

The demapper 530 demodulates a modulated signal. The signal that is demodulated in the demapper 530 may be converted to original data through the descrambler 540, the deinterleaver 550, and the decoder 560. In this case, a receiving terminal to which a high power rate is allocated determines data that is converted through the decoder 560 to a signal thereof. However, a receiving terminal to which a low power rate is allocated feeds back data that is converted through the decoder 560 to the demapper 530 by one or more of interleaving, scrambling, and mapping.

Therefore, a receiving terminal according to according to an exemplary embodiment of the present invention may include two (two pairs of) demappers 530, descramblers 540, deinterleavers 550, and decoders 560, as shown in an upper drawing of FIG. 5, and may include one (a pair of) demapper 530, descrambler 540, deinterleaver 550, and decoder 560, as shown in a lower drawing of FIG. 5. A receiving terminal according to an exemplary embodiment of the present invention includes an interleaver 570, a scrambler 580, and a mapper 590 for interleaving, scrambling, and mapping.

In an exemplary embodiment of the present invention, the base station 100 determines a time point to transmit data to a terminal that requests data transmission and allocates a resource. In an FDMA method, a frequency resource is divided and allocated, and in a TDMA method, a time resource is divided and allocated. In an exemplary embodiment of the present invention, by adding a power allocation method to an FDMA or a TDMA method, performance and efficiency of a communication system can be enhanced.

In a power allocation method according to an exemplary embodiment of the present invention, it is necessary for the base station 100 to select two or three simultaneous transmitting terminals. According to an exemplary embodiment of the present invention, when channel states of each terminal are very different, the power allocation method is effective. That is, when channel states of the simultaneous transmitting terminals are similar, a performance improvement is slight or does not exist.

For example, because a UE3 130 and a UE4 140 of FIG. 1 are located at adjacent locations, each SNR has little difference. In this case, when the base station 100 allocates a power rate of 0.2:0.8 to the UE3 130 and the UE4 140, a capacity of the UE3 130 is 1.58 bit/s/Hz and a capacity of the UE4 140 is 1.87 bit/s/Hz (total capacity: 1.58+1.87=3.45). The performance has no difference, compared with a capacity of 1.73 bit/s/Hz (total capacity=3.46)) when the UE3 130 and the UE4 140 are accessed with an FDMA or TDMA method.

A modulation method of a simultaneous transmitting terminal is QPSK+QPSK or QPSK+16QAM when there are 2 simultaneous transmitting terminals and is QPSK+QPSK+QPSK when there are 3 simultaneous transmitting terminals. In this case, a modulation method of the HPR terminal is relatively set to QPSK. This is because it is difficult for the HPR terminal to select a modulation method that does not have good channel environment and that has a high code rate. For example, even if a channel environment between terminals has an SNR of 20 dB in the base station 100, when a power rate of 0.75 is allocated to the terminal, the SNR is recalculated to 4.6 dB, when a power rate of 0.8 is allocated to the terminal, the SNR is recalculated to 5.8 dB, and when a power rate of 0.9 is allocated to the terminal, the SNR is recalculated to 9.13 dB.

FIG. 6 is a flowchart illustrating a method in which a base station selects a simultaneous transmitting terminal according to an exemplary embodiment of the present invention.

Referring to FIG. 6, the terminal selection processor 200 of the base station 100 selects a first terminal according to priority transmitting order (S601). Thereafter, the terminal selection processor 200 determines whether to simultaneously transmit data in consideration of a size or a kind of data to transmit to the first terminal (S602).

When simultaneous transmission is determined, the terminal selection processor 200 determines the number of simultaneous transmitting terminals in consideration of a channel environment with the first terminal (S603). In this case, according to an exemplary embodiment of the present invention, the terminal selection processor 200 determines whether the number of simultaneous transmitting terminals is 2 or 3 (S604). That is, in addition to the first terminal, one or two terminals may be additionally determined as simultaneous transmitting terminals.

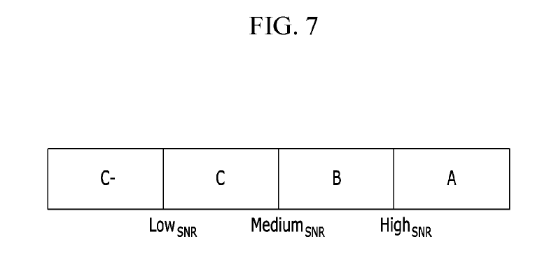

Thereafter, the terminal selection processor 200 determines a second SNR segment in which a second terminal that can simultaneously transmit data is to be selected according to a first SNR segment at which the first terminal is located (S607). For when there are 2 simultaneous transmission terminals, a second SNR segment that can be selected according to a first SNR segment will be described through FIG. 7 and Table 1.

FIG. 7 is a diagram illustrating an SNR segment of a terminal according to an exemplary embodiment of the present invention.

A segment of FIG. 7 is divided according to an SNR of a terminal, and at some SNR segments, a modulation method of a terminal having a bad channel state among two or more simultaneous transmitting terminals may be fixed to QPSK.

When a terminal that is included at a segment A is selected, a low power rate may be allocated to the selected terminal, and 16QAM may be used as a modulation method. When a terminal that is included at a segment B is selected, both the LRP terminal and the HPR terminal may use QPSK as a modulation method. When a terminal that is included at a segment C is selected, a high power rate may be allocated to the selected terminal and QPSK may be used as a modulation method. When a terminal that is included at a segment C− is selected, a high power rate may be allocated to the selected terminal, and a modulation method of a low code rate may be used.

Thereafter, the terminal selection processor 200 determines a second SNR segment in which a second terminal that can simultaneously transmit data is to be selected according to a first SNR segment at which the first terminal is located (S605). Table 1 represents a second SNR segment that can select according to a first SNR segment at which a first terminal is located according to an exemplary embodiment of the present invention.

TABLE 1

| First | Second | Additional |
|---|---|---|
| SNR segment | SNR segment | SNR segment |
| A | B, C, C− | A |
| B | A, C, C− | B |
| C | A, B | — |
| C− | A, B | — |

As described above, as an SNR difference between simultaneous transmitting terminals increases, a power allocation method according to an exemplary embodiment of the present invention may represent effective performance and thus the SNR segments may be matched, as shown in Table 1.

Thereafter, the terminal selection processor 200 selects a second terminal as a second simultaneous transmitting terminal in consideration of priority transmitting order and a size and a kind of requiring data among terminals that are included at the second SNR segment (S606). For example, when the first terminal is located at the segment B, the terminal selection processor 200 may select the second terminal at one segment of the segment A, the segment C, and the segment C−.

When priority transmitting order of a terminal that is located at the second SNR segment is remarkably low or when the terminal does not exist at the second SNR segment, the terminal selection processor 200 may select the second terminal at an additional SNR segment.

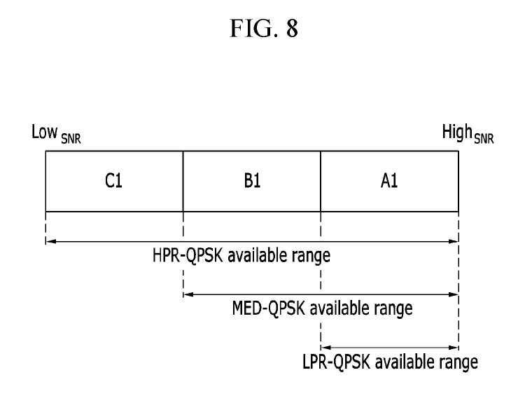

When the terminal selection processor 200 determines there are 3 simultaneous transmitting terminals, the terminal selection processor 200 determines a second SNR segment according to the first SNR segment at which the first terminal is located and determines a third SNR segment according to the determined second SNR. For when there are 3 simultaneous transmission terminals (UE5 150, UE6 160, and UE7 170), the second SNR segment and the third SNR segment that can be selected according to the first SNR segment will be described with reference to FIG. 8 and Table 2.

FIG. 8 is a diagram illustrating an SNR segment of a terminal according to another exemplary embodiment of the present invention.

A QPSK method is applied to a terminal that is included at an entire segment of FIG. 8. That is, a modulation method is not changed according to a segment. As shown in FIG. 7, a segment of FIG. 8 is divided according to an SNR of a terminal.

A low power rate may be allocated to a terminal that is included at a segment A1, a medium power rate may be allocated to a terminal that is included at a segment B1, and a high power rate may be allocated to a terminal that is included at a segment C1. That is, when transmitting a signal with high power to a terminal that is included at the segment C1, a signal may be demodulated.

Thereafter, the terminal selection processor 200 determines a third SNR segment based on the second SNR segment (S608). Table 2 represents a second SNR segment and a third SNR segment that can be selected according to a first SNR segment at which a first terminal is located according to another exemplary embodiment of the present invention.

TABLE 2

| | | Third SNR segment | |
|---|---|---|---|
| First | Second | Selected second | Third |
| SNR segment | SNR segment | SNR segment | SNR segment |
| A1 | A1, B1, C1 | A1 or B1 | A1, B1, C1 |
| | | C1 | A1, B1 |
| B1 | A1, B1, C1 | A1 | A1, B1, C1 |
| | | B1 | A1 |
| | | C1 | A1 |
| C1 | A1, B1 | A1 | A1, B1 |
| | | B1 | A1 |

Thereafter, the terminal selection processor 200 selects a second terminal and a third terminal in consideration of priority transmitting order and a size and a kind of requiring data among terminals that are included at the second SNR segment and the third SNR segment (S609). Referring to Table 2, at a segment A1, at least one terminal may be selected, and at a segment C1, a maximum of one terminal may be selected. This is because a range that can be demodulated is determined according to a magnitude of allocated power. When the terminal selection processor 200 selects three simultaneous transmitting terminals, a performance difference according to a selection segment is not large and thus an additional SNR segment may not be set.

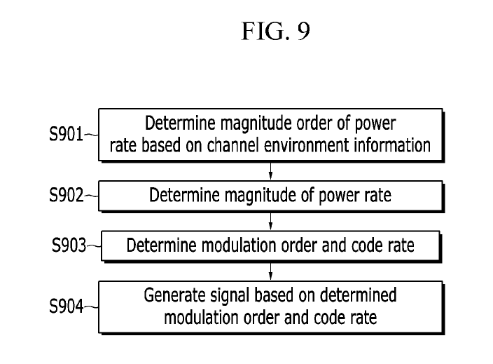

As described above, after a simultaneous transmitting terminal is selected, the terminal selection processor 200 allocates a power rate to each simultaneous transmitting terminal according to a channel state and determines a modulation order and a code rate. FIG. 9 illustrates a method of determining a power rate, a modulation order, and a code rate.

FIG. 9 is a flowchart illustrating a method of generating a signal according to an exemplary embodiment of the present invention.

FIG. 9 illustrates a method of transmitting a signal when there are 3 simultaneous transmitting terminals. Referring to FIG. 9, the terminal selection processor 200 determines magnitude order of a power rate to be allocated based on channel environment information of each simultaneous transmitting terminal (a first terminal, a second terminal, and a third terminal) (step of determining a relative magnitude of a power rate) (S901). For example, a largest power rate may be allocated to the second terminal in which a channel environment is not good, a smallest power rate may be allocated to a first terminal in which a channel environment is good, and in this case, a magnitude order is the second terminal>the third terminal>the first terminal.

Thereafter, the terminal selection processor 200 may determine a magnitude of a power rate to allocate to each terminal (S902). It is a selective configuration in which the terminal selection processor 200 specifically determines a magnitude of a power rate. For example, when the terminal selection processor 200 determines only a relative magnitude of a power rate, the terminal selection processor 200 may modulate each data with a predetermined modulation method in the mapper 240 and multiply each of predetermined power by the modulated data.

A power rate of each terminal may be allocated so as to not be seriously interfered with when adding and transmitting demodulation information of each terminal. As described above, when data to transmit to a terminal in which a power rate of a medium magnitude is allocated (hereinafter referred to as an ‘MPR terminal’) or to an LPR terminal increases, a constellation form of data to transmit to an HPR terminal is distorted and data may not be demodulated upon receipt.

Further, because a channel environment of the HPR terminal is not good, when a decision distance between output data is far, it is considered that performance is good. According to an exemplary embodiment of the present invention, because there are 2 or 3 simultaneous transmitting terminals, a constellation of a final output signal may be similar to 16QAM or 64QAM.

For example, when the terminal selection processor 200 determines the HPR to a value between 0.75-0.8, the terminal selection processor 200 may minimize interference due to the MPR terminal or the LRP terminal. When the HPR is 0.7 or less, a constellation gap of an output signal may become small by data to transmit to the LPR terminal and sensitively react even to small noise. However, at a C-segment of Table 1 in which a channel environment is very bad, a method of determining HPR to be 0.9 may be considered, but a method of guaranteeing performance by lowering a code rate rather than a method of increasing a power rate may be advantageous to a terminal that receives allocation of a low power rate.

Therefore, in an exemplary embodiment of the present invention, a power rate of 0.75 or more is allocated to the HPR terminal based on a constellation when transmitting a signal that is modulated with 64QAM with a power rate of 1 to a terminal.

Table 3 represents a magnitude of a power rate that is allocated to each terminal according to an exemplary embodiment of the present invention.

TABLE 3

| | When the number of | | |
|---|---|---|---|
| | simultaneous transmission | | When the number of |
| | terminals is 2 | | simultaneous transmission |
| | LPR - QPSK | LPR - 16QAM | terminals is 3 |
| HPR | 0.8 or more | 0.75 or more | 0.75 or more |
| MPR | — | — | (1-HPR) × 0.8 or more |

In Table 3, when the number of simultaneous transmitting terminals is 2, if 16QAM is applied to data of the LPR terminal and a power rate of 0.75 is applied to the HPR terminal, a constellation of an output signal may be the same as that of 64QAM. However, when a power rate that is allocated to the HPR terminal excessively increases, a gap of data to be transmitted to the LPR terminal on the constellation becomes small and thus demodulation may fail and a power rate that is allocated to the LPR terminal reduces such that an SNR may also be reduced. In contrast, when a power rate that is allocated to the HPR terminal is 0.7, data to be transmitted to the HPR terminal approaches a shaft on a constellation due to data to be transmitted to the LPR terminal and thus a performance may be deteriorated, and a probability that an error may occur in the LPR terminal in a process of removing data to be transmitted to the HPR terminal may increase.

Thereafter, when a power rate is applied to each terminal, the terminal selection processor 200 may determine a modulation order and a code rate to apply to data to be transmitted to each terminal (S903). In this case, the determined modulation order and code rate of each data may be transmitted to the mapper 240.

The HPR terminal and the MPR terminal use QPSK modulation as basic modulation. In an exemplary embodiment of the present invention, after a modulation order and a code rate determine a plurality of candidate sets that are determined according to a power rate, each of the plurality of candidate sets is simulated and thus an optimal set may be determined.

Thereafter, the base station 100 generates a signal to transmit to a terminal based on the determined modulation order and code rate and transmits the generated signal (S904).

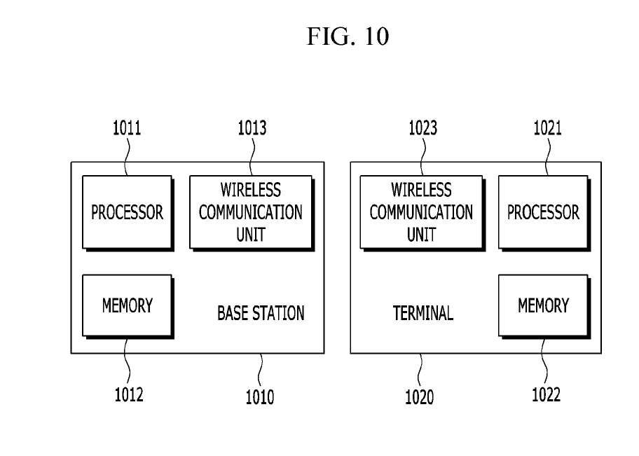

FIG. 10 is a block diagram illustrating a wireless communication system according to another exemplary embodiment of the present invention.

Referring to FIG. 10, the wireless communication system according to the exemplary embodiment of the present invention includes a base station 1010 and a terminal 1020.

The base station 1010 includes a processor 1011, a memory 1012, and a radio frequency (RF) unit 1013. The memory 1012 is connected with the processor 1011 to store various information for driving the processor 1011. The RF unit 1013 is connected with the processor 1011 to transmit and/or receive a radio signal. The processor 1011 may implement a function, a process, and/or a method which are proposed in the present invention. In this case, in the wireless communication system according to the exemplary embodiment of the present invention, a radio interface protocol layer may be implemented by the processor 1011. An operation of the base station 1010 according to the exemplary embodiment of the present invention may be implemented by the processor 1011.

The terminal 1020 includes a processor 1021, a memory 1022, and an RF unit 1023. The memory 1022 is connected with the processor 1021 to store various information for driving the processor 1021. The RF unit 1023 is connected with the processor 1021 to transmit and/or receive the radio signal. The processor 1021 may implement a function, a process, and/or a method which are proposed in the present invention. In this case, in the wireless communication system according to the exemplary embodiment of the present invention, the radio interface protocol layer may be implemented by the processor 1021. An operation of the terminal 1020 according to the exemplary embodiment of the present invention may be implemented by the processor 1021.

In the exemplary embodiment of the present invention, the memory may be positioned inside or outside the processor, and the memory may be connected with the processor through various already known means. The memory is various types of volatile or non-volatile storage media, and the memory may include, for example, a read-only memory (ROM) or a random access memory (RAM).

As described above, by allocating appropriate power to a signal toward each terminal through a power allocation method according to an exemplary embodiment of the present invention, even if data are simultaneously transmitted using the same frequency and time resource, interference can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of simultaneously transmitting data to a plurality of terminals, the method comprising:
selecting a plurality of simultaneous transmitting terminals based on a signal-to-noise ratio (SNR) of the plurality of terminals;
allocating a power rate of the plurality of simultaneous transmitting terminals to each of the plurality of simultaneous transmitting terminals;
modulating each of the data according to a modulation method that is determined based on the power rate; and
transmitting the modulated data according to the power rate.

2. The method of claim 1, wherein the selecting of a plurality of simultaneous transmitting terminals comprises:
determining whether to simultaneously transmit to the simultaneous transmitting terminals; and
determining the number of simultaneous transmitting terminals.

3. The method of claim 2, wherein the determining of whether to simultaneously transmit comprises:
selecting a first terminal of the plurality of terminals according to a priority transmitting order as the simultaneous transmitting terminal; and
determining whether to simultaneously transmit in consideration of a size or a kind of first data to transmit to the first terminal.

4. The method of claim 3, wherein the determining of the number of the simultaneous transmitting terminals comprises:
determining the number of the simultaneous transmitting terminals in consideration of a channel environment of the first terminal; and
selecting, when there are 2 simultaneous transmitting terminals, a second terminal of the plurality of terminals as the simultaneous transmitting terminal in consideration of an SNR of the first terminal.

5. The method of claim 4, wherein the selecting of a second terminal comprises:
dividing an SNR of the plurality of terminals into n segments according to intensity;
selecting a second segment at remaining n-1 segments instead of a first segment of the n segments, when an SNR of the first terminal belongs to a first segment of the n segments; and
selecting a second terminal having an SNR corresponding to the second segment.

6. The method of claim 5, wherein the allocating of a power rate comprises allocating, when an SNR of the first terminal is larger than that of the second terminal, a power rate larger than that of the first terminal to the second terminal.

7. The method of claim 5, wherein the modulating of each of the data comprises modulating, when an SNR of the first segment is largest at the n segments, the first data with a 16 quadrature amplitude modulation (QAM) method.

8. The method of claim 5, wherein the modulating of each of the data comprises modulating, when an SNR of the first segment is smallest at the n segments, the first data with a quadrature phase shift keying (QPSK) method.

9. The method of claim 5, wherein the modulating of each of the data comprises changing and modulating a modulation order of the first data and second data to transmit to the second terminal.

10. The method of claim 3, wherein the determining of the number of simultaneous transmitting terminals comprises:
determining the number of simultaneous transmitting terminals in consideration of a channel environment of the first terminal; and
selecting, when there are 3 simultaneous transmitting terminals, a second terminal of the plurality of terminals as the simultaneous transmitting terminal in consideration of an SNR of the first terminal, and selecting a third terminal of the plurality of terminals as the simultaneous transmitting terminal in consideration of an SNR of the second terminal.

11. The method of claim 10, wherein the selecting of a third terminal comprises:
classifying an SNR of the plurality of terminals into m segments according to intensity; and
selecting at least one of the simultaneous transmitting terminals at a segment in which the SNR is largest among the m segments.

12. The method of claim 10, wherein the allocating of a power rate comprises, when an SNR of the first terminal is smallest, an SNR of the second terminal is largest, and an SNR of the third terminal is larger than that of the first terminal and is smaller than that of the second terminal, allocating a largest power rate to the first terminal, allocating a smallest power rate to the second terminal, and allocating a power rate smaller than a power rate that is allocated to the first terminal and larger than a power rate that is allocated to the second terminal to the third terminal.

13. The method of claim 10, wherein the modulating of each of the data comprises modulating the first data, second data to transmit to the second terminal, and third data to transmit to the third terminal with a quadrature phase shift keying (QPSK) method.

14. The method of claim 10, wherein the modulating of each of the data comprises changing and modulating each modulation order of the first data, second data to transmit to the second terminal, and third data to transmit to the third terminal.

15. An apparatus that simultaneously transmits data to a plurality of terminals, the apparatus comprising:
a terminal selection processor that selects a plurality of simultaneous transmitting terminals based on a signal-to-noise ratio (SNR) of the plurality of terminals, and that allocates a power rate to each of the plurality of simultaneous transmitting terminals; and
a mapper that modulates each of the data according to a modulation method that is determined based on the power rate and that outputs the modulated data according to the power rate.

16. The apparatus of claim 15, wherein the terminal selection processor selects a first terminal of the plurality of terminals as the simultaneous transmitting terminal according to a priority transmitting order, determines whether to simultaneously transmit, and determines the number of simultaneous transmitting terminals in consideration of a size or a kind of first data to transmit to the first terminal.

17. The apparatus of claim 16, wherein the terminal selection processor determines the number of simultaneous transmitting terminals in consideration of a channel environment of the first terminal and selects a second terminal of the plurality of terminals as the simultaneous transmitting terminal in consideration of an SNR of the first terminal, when there are 2 simultaneous transmitting terminals.

18. The apparatus of claim 16, wherein the terminal selection processor determines the number of the simultaneous transmitting terminals in consideration of a channel environment of the first terminal, selects a second terminal of the plurality of terminals as the simultaneous transmitting terminal in consideration of an SNR of the first terminal, and selects a third terminal of the plurality of terminals as the simultaneous transmitting terminal in consideration of an SNR of the second terminal, when there are 3 simultaneous transmitting terminals.

19. The apparatus of claim 15, wherein the terminal selection processor determines a modulation order and a code rate of the data and transmits the modulation order and the code rate to the mapper, and the mapper modulates each of the data based on the modulation order and the code rate.

20. The apparatus of claim 15, wherein the terminal selection processor determines a relative magnitude of the power rate and allocates the relative magnitude to the plurality of simultaneous transmitting terminals, and the mapper modulates each of the data according to a predetermined modulation method based on the relative magnitude.
